(19) United States
(12) Patent Application Publication
(10) Pub. No.: US 2008/0169762 A1
(43) Pub. Date: Jul. 17, 2008

(54) Plasma display panel

(76) Inventor: Jung-Suk Song, Suwon-si (KR)

Correspondence Address: ROBERT E. BUSHNELL, 1522 K STREET NW, SUITE 300, WASHINGTON, DC, 20005-1202, US

(21) Appl. No.: 11/892,546

(22) Filed: Aug. 23, 2007

(30) Foreign Application Priority Data
Jan. 17, 2007 (KR) 10-2007-0005442

(51) Int. Cl. H01J 17/49

(52) U.S. Cl. 313/584

(57) ABSTRACT

A plasma display panel is constructed with a substrate, a plurality of discharge electrodes that are located on the substrate and include a pair of sustain discharge electrodes that generate sustain discharge and address electrodes crossing the sustain discharge electrodes, a plurality of barrier ribs that are located on the substrate to define a plurality of discharge cells and have volume enlargement portions; and phosphor layers formed in the discharge cells.

### CLAIM OF PRIORITY

This application makes reference to, incorporates the same herein, and claims all benefits accruing under 35 U.S.C. §119 from an application for PLASMA DISPLAY PANEL earlier filed in the Korean Intellectual Property Office on 17 Jan. 2007 and there duly assigned Serial No. 10-2007-0005442.

### BACKGROUND OF THE INVENTION

The present invention relates to a plasma display panel, and more particularly, to a plasma display panel that can prevent distortion of barrier ribs.

### DESCRIPTION OF THE RELATED ART

A plasma display panel (PDP) is a flat display panel that displays selected variable stationary or moving visual video images such as numbers, letters, or graphics using visible light emitted from a phosphor layer which is excited by ultraviolet rays generated from a discharge gas that fills in sealed spaces between opposing substrates on which a plurality of discharge electrodes are formed.

PDPs are classified into direct current (DC) types and alternating current (AC) types according to the types of driving voltage applied to the discharge cells, or, alternatively, into facing discharge types and surface discharge types according to the configuration of discharge electrodes.

A three-electrode surface discharge type PDP is typically constructed with a first substrate, a second substrate, sustain discharge electrode pairs on the inner side of the first substrate, a first dielectric layer that buries the sustain discharge electrode pairs, a protective film layer formed on the surface of the first dielectric layer, a plurality of address electrodes that are formed on the inner side of the second substrate and cross the sustain discharge electrode pairs, a second dielectric layer that buries the address electrodes, a plurality of barrier ribs located between the first and second substrates to define a plurality of discharge cells, and red, green, and blue phosphor layers coated on the walls of the barrier ribs.

In the PDP having the above structure, when an electrical signal is applied between the address electrodes and Y electrodes of the sustain discharge electrode pairs, discharge cells for emitting light are selected. When another electrical signal is alternately applied to X electrodes and Y electrodes, visible light is emitted from the phosphor layers coated in the selected discharge cells. Thus, a stationary or moving image can be visually displayed.

In order to fabricate barrier ribs in the PDP, a paste made from a raw material for forming the barrier ribs is printed onto an upper surface of the second dielectric layer and is subsequently dried, and a dry film resistor (DFR) is laminated onto the paste. Subsequently, a photomask is attached to the DFR. After exposing the second substrate with the paste and the DFR, a developing agent is injected from an edge of the second substrate to develop the DFR.

Next, the raw material for forming the barrier ribs is removed by sand blasting. The remaining DFR is exfoliated. The fabrication of the barrier ribs is complete when the resultant product is fired.

A contemporary high definition class panel is constructed with barrier ribs having a width of approximately sixty micrometers. In order to display a full high definition image, however, the width of the barrier ribs is reduced below sixty micrometers. If the barrier ribs have a width of approximately thirty-five micrometers, some portions of the barrier ribs might become distorted.

The distorting is usually due to the fact that when the width of the barrier ribs is reduced, adhesion between the dry film resistor (DFR) and the raw material is loosened during the developing process, and as a result, the DFR may be detached from the barrier ribs. Thus, some portions of the barrier ribs may become distorted during the sand blasting process.

In particular, the distorting portions of the barrier ribs may be located on the edge regions of the panel due to different injection velocities of the developing agent in a central region and the edge regions when the developing agent is injected into the panel. That is, the developing agent is usually injected from the edge of the panel. Accordingly, the velocity of the developing agent is higher at the edge regions than in the central region. Therefore, the detached DFRs on the edge regions may result in the distortion of some portions of the barrier ribs during developing.

### SUMMARY OF THE INVENTION

It is therefore an object of the present invention to provide an improved plasma display panel.

It is another object to provide a plasma display panel that can prevent distortion of barrier ribs at edge regions of the plasma display panel by modifying the structure of the barrier ribs at the edge regions.

According to an aspect of the present invention, a plasma display panel maybe constructed with a substrate, a plurality of discharge electrodes located on the substrate, and a plurality of barrier ribs that define a plurality of discharge cells and are formed with volume enlargement portions.

The barrier ribs may comprise at least one portion which is relatively longer than another portion, and the volume enlargement portions may be formed on the longer portion. The volume enlargement portions may be formed by increasing the volume of central portion of the longer portions of the barrier ribs that are located between two adjacent shorter portions of the barrier ribs.

The barrier ribs may be constructed with first barrier ribs that extend in one direction of the substrate and second barrier ribs that extend in another direction of the substrate and are coupled to the first barrier ribs to surround each one of the plurality of discharge cells.

The second barrier ribs may be longer than the first barrier ribs, and the volume enlargement portions may be formed in central portions of the second barrier ribs that are located between two adjacent first barrier ribs.

The substrate may be constructed with a display area where images are displayed and a non-display area where the discharge electrodes are electrically connected to external terminals, and the barrier ribs on which the volume enlargement portions are formed may be formed along edge regions of the display area.

According to another aspect of the present invention, a plasma display panel may be constructed with a plurality of substrates, a plurality of discharge electrodes that are located on the substrate and provide pairs of sustain discharge electrodes that generate sustain discharge and address electrodes crossing the sustain discharge electrodes, a plurality of barrier ribs that are located on the substrate to define a plurality of discharge cells and are constructed with volume enlargement portions, and phosphor layers formed in the discharge cells.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a photograph of barrier ribs with distorted portion;

FIG. 2 is a plan view of a plasma display panel constructed as an embodiment of the principles of the present invention;

FIG. 3 is an exploded oblique view of the plasma display panel of FIG. 2 according to the embodiment of the principles of the present invention;

FIG. 4 is a plan view of the barrier ribs shown in FIG. 3 according to the embodiment of the principles of the present invention; and

FIG. 5 is an enlarged plan view of a portion of the barrier ribs shown in FIG. 4 according to the embodiment of the principles of the present invention.

### DETAILED DESCRIPTION OF THE INVENTION

The present invention will now be described more fully with reference to the accompanying drawings, in which exemplary embodiments of the invention are shown.

A contemporary high definition (HD) class panel is typically constructed with barrier ribs having a width of sixty micrometers. In order to display a full HD image, however, the width of the barrier ribs is required to be reduced below sixty micrometers. As depicted in FIG. 1, if barrier ribs 101 have a width of approximately thirty-five micrometers, portions 102 of barrier ribs 101 are likely to be distorted.

The distortion is usually due to the fact that when the width of barrier ribs 101 is reduced, adhesion between a dry film resistor (DFR) used for forming barrier ribs 101 and a raw material for forming barrier ribs 101 is loosened during a developing process, and as a result, the DFR may be detached from barrier ribs 101. Thus, portions 102 of barrier ribs 101 may become distorted during a subsequent sand blasting process.

Specifically, distorted portions 102 of barrier ribs 101 are located on the edge regions of the panel due to different injection velocities of a developing agent in a central region and the edge regions when the developing agent is injected into the panel. That is, the developing agent is usually injected from the edge of the panel. Accordingly, the velocity of the developing agent is higher at the edge regions than in the central region. Therefore, the DFRs on the edge regions may be detached from the raw material during the developing process, and thus result in the distortion of some portions of barrier ribs 101 during the sand blasting process.

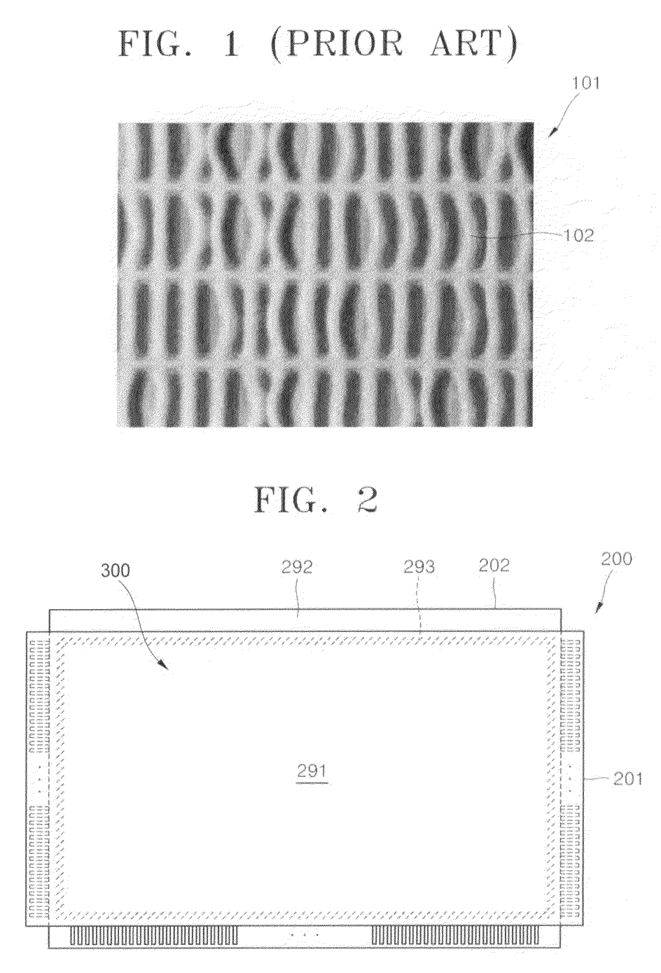

FIG. 2 is a plan view of a plasma display panel (PDP) 200 constructed as an embodiment according to the principles of the present invention.

Referring to FIG. 2, PDP 200 is constructed with a first substrate 201 and a second substrate 202 that is coupled to first substrate 201. When first and second substrates 201 and 202 are coupled, a central area where first and second substrates 201 and 202 overlap can be a display area 291, and an area of one of first and second substrates 201 and 202 that is exposed at an edge of display area 291 can be a non-display area 292.

Display area 291 includes a region in which various functional layers such as a plurality of electrodes (not shown), dielectric layers (not shown), a plurality of barrier ribs (not shown), phosphor layers (not shown) are arranged on successive layers in various patterns between first and second substrates 201 and 202, and displays video images when PDP 200 is electrically driven. Non-display area 292 includes a region having electrode terminals (not shown) extending from the electrodes in display area 291, and is electrically connected to signal transmitting units (not shown).

Frit glass 293 is coated on a boundary region between display area 291 and non-display area 292 to seal display area 291 from the outside.

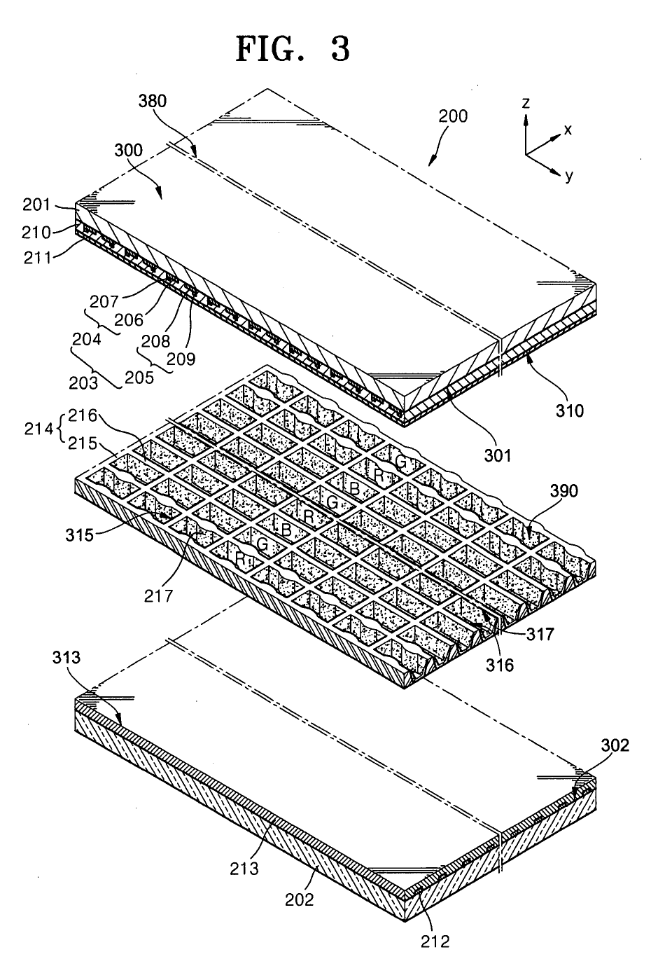

FIG. 3 is an exploded oblique view of PDP 200 of FIG. 2, according to the embodiment of the principles of the present invention. Referring to FIG. 3, PDP 200 is constructed with first substrate 201 and second substrate 202 spaced apart and parallel to first substrate 201. A plurality of barrier ribs 214 are formed between first substrate 201 and second substrate 202. Barrier ribs 214 define the space between first substrate 201 and second substrate 202 into a plurality of discharge cells 390 and prevent cross-talk between adjacent discharge cells 390.

First substrate 201 can be a transparent substrate made from soda lime glass, a semi-transparent substrate, a reflective substrate, or a colored substrate.

Sustain discharge electrode pairs 203 are located on inner surface 301 of first substrate 201. Sustain discharge electrode pairs 203 include X electrodes 204 and Y electrodes 205. A pair of X electrode 204 and Y electrode 205 is located in spacial alignment corresponding to each discharge cell 390.

Each of X electrodes 204 includes a first transparent electrode 206 extending along the X direction of PDP 200, and a first bus electrode line 207 electrically connected to first transparent electrode 206. Each of Y electrodes 205 includes a second transparent electrode 208 extending along the X direction of PDP 200, and a second bus electrode line 209 electrically connected to second transparent electrode 208.

First transparent electrodes 206 and second transparent electrodes 208 are separately disposed in each discharge cell 390, and each of first transparent electrodes 206 and second transparent electrodes 208 have a rectangular horizontal cross-section. First bus electrode lines 207 and second bus electrode lines 209 have a strip shape that extends across discharge cells 390 which are adjacently formed along the X direction of PDP 200.

First transparent electrodes 206 and second transparent electrodes 208 are made from an electrically conductive film that is transparent to light across the visible spectrum such as an indium tin oxide (ITO) film. First bus electrode lines 207 and second bus electrode lines 209 are made from a metal having higher electrical conductivity than that of the transparent electrodes, for example, Ag or Cr—Cu—Cr.

Sustain discharge electrode pairs 203 are buried by first dielectric layer 210 made from a dielectric that is transparent to light across visible spectrum, for example, a dielectric material such as PbO—B₂O₃—SiO₂.

Protective film layer 211 is formed on surface 310 of first dielectric layer 210 using MgO to increase the emission rate of secondary electrons.

Second substrate 202 can be a transparent substrate, a semi-transparent substrate, a reflective substrate, or a colored substrate. A plurality of address electrodes 212 are located on inner surface 302 of second substrate 202 in a direction crossing Y electrodes 205.

Address electrodes 212 have a strip shape and extend across discharge cells 390 which are adjacently formed along the Y direction of PDP 200. Address electrodes 212 are made from a metal having an electrical conductivity, for example, an Ag paste. Address electrodes 212 are buried in a second dielectric layer 213 made from a dielectric material like first dielectric layer 210.

Barrier ribs 214 include first barrier ribs 215 disposed in the X direction of PDP 200 and second barrier ribs 216 disposed in the Y direction of PDP 200. First barrier ribs 215 extend from inner wall 316 of second barrier rib 216 toward inner wall 317 of another second barrier rib 216 to define discharge cells 390.

The structure of barrier ribs 214 is not limited to the geometric shapes shown in the foregoing drawings. That is, barrier ribs 214 can be formed in any geometric construct or shape that can define discharge cells 390, for example, a polygonal shape including a rectangle, or a circle or oval shape.

A discharge gas such as Ne—Xe gas or He—Xe gas is injected into a discharge space defined by the combination of first substrate 201, second substrate 202, and barrier ribs 214.

A phosphor layer 217 is formed in each of discharge cells 390. Phosphor layer 217 emits visible light when excited by ultraviolet rays generated from the discharge gas during gas discharge. Phosphor layer 217 can be coated on any region in discharge cell 390, and in the present embodiment, phosphor layer 217 is formed on upper surface 313 of second dielectric layer 213 and on inner walls 315 of first barrier ribs 215.

Phosphor layer 217 may include red, green, and blue phosphor layers, but phosphor layer 217 according to the principles of the present invention is not limited thereto. In the present embodiment, the red phosphor layer is made from (Y,Gd)BO₃:Eu⁺³, the green phosphor layer is made from Zn₂SiO₄:Mn²⁺, and the blue phosphor layer is made from BaMgAl₁₀O₁₇:Eu²⁺.

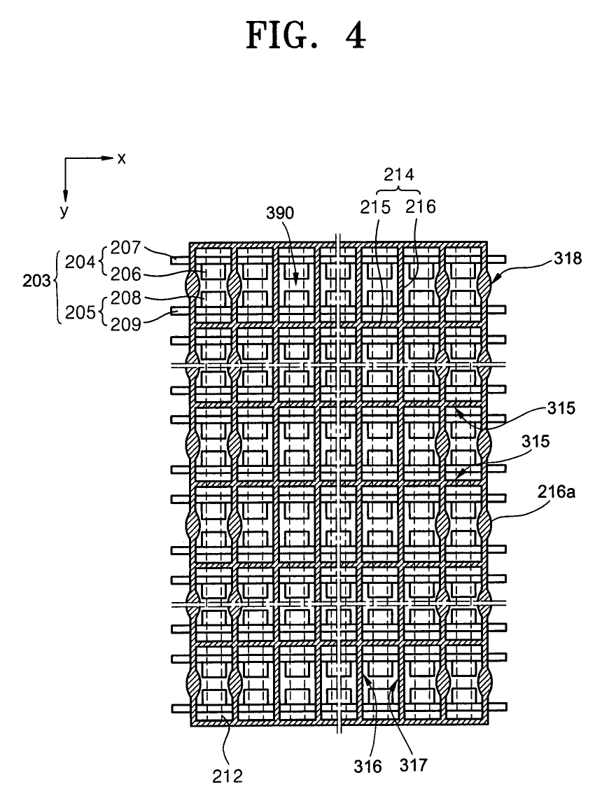

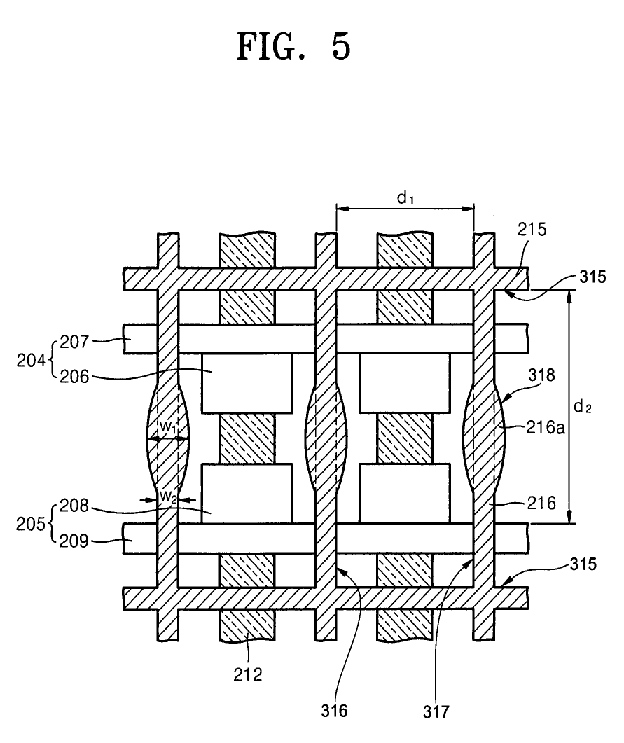

The barrier ribs 214 disposed on edge regions 300 of first substrate 201 and second substrate 202 are constructed with volume enlargement portions 216a, which will be described in detail with reference to FIGS. 4 and 5.

FIG. 4 is a plan view of sustain discharge electrode pairs 203, address electrodes 212, and barrier ribs 214 of FIG. 3, according to the embodiment of the principles of the present invention, and FIG. 5 is an enlarged view of a portion of FIG. 4. In the drawings, like reference numerals refer to like elements performing the same functions.

Referring to FIGS. 4 and 5, barrier ribs 214 include first barrier ribs 215 extending in the X direction of PDP 200 and second barrier ribs 216 extending in the Y direction of PDP 200. First barrier ribs 215 extend from inner wall 316 of second barrier rib 216 toward inner wall 317 of another second barrier rib 216 to define a matrix of discharge cells 390.

Each discharge cell 390 surrounded by first barrier ribs 215 and second barrier ribs 216 has a rectangular shape. In the rectangular discharge cell 390, second barrier rib 216 has a length d2 greater than length d1 of first barrier rib 215.

Barrier ribs 214 located at edge regions 300 of PDP 200 are formed with volume enlargement portions 216a. That is, as depicted in FIG. 2, PDP 200 includes display area 291 where an image is displayed and non-display area 292 at the edges of display area 291, and the barrier ribs 214 formed with volume enlargement portions 216a are located at edge regions 300 of display area 291. Specifically, the barrier ribs 214 formed with volume enlargement portions 216a are located at regions 300 of display area 291 where a dry film resistor (DFR) (not shown) enters and reacts in the first place with a developing agent (not shown) injected from a barrier developing apparatus (not shown) for fabricating barrier ribs 216.

Volume enlargement portions 216a can be formed on either first barrier ribs 215 or second barrier ribs 216. Volume enlargement portions 216a are preferably formed on second barrier ribs 216, which are longer than first barrier ribs 215. This is because second barrier ribs 216 are longer and thus may distort more due to the detachment of the DFR than first barrier ribs 215 during the developing process.

Volume enlargement portions 216a are formed at central portions 318 of second barrier ribs 216 which are located between two adjacent first barrier ribs 215. Volume enlargement portions 216a are formed by increasing the volume of second barrier ribs 216 from side walls 315 of two adjacent first barrier ribs 215 toward central portions 318. Accordingly, width W1 of central portions 318 of second barrier ribs 216 is greater than width W2 of second barrier ribs 216 close to side walls 316.

Swelling portion 216a, i.e., volume enlargement portions 216a, according to the present invention is not limited to the embodiment as shown in FIGS. 3 to 5. That is, swelling portion 216a can be formed as any shape as long as central portion 318 of second barrier rib 216 is enlarged relative to other portions of second barrier rib 216. Also, volume enlargement portions 216a can be modified to have various forms, for example, volume enlargement portions 216a can be formed at portions of barrier ribs 214 where the degree of distorting is greater than other regions due to the relatively long length of barrier ribs 214. Alternatively, instead of forming the volume enlargement portions on the barrier ribs located only at edge regions 300 of PDP 200, the volume enlargement portions can be formed on the barrier ribs from center 380 of PDP 200 towards edge regions 300 of PDP 200 by varying the volume of the volume enlargement portions according to the degree of distorting of the barrier ribs.

Barrier ribs 216 on which volume enlargement portions 216a are formed, are parallel to address electrodes 212.

A method for manufacturing barrier ribs 214 having the above structure according to the principles of the present invention will now be described.

Second substrate 202 is prepared from glass. Address electrodes 212 having a stripe shape are formed using an electrically conductive material on upper surface 302 of second substrate 202 and subsequently patterned. Address electrodes 212 are buried by printing white second dielectric layer 213 onto patterned address electrodes 212.

Next, a paste made from a raw material for forming barrier ribs 214 is printed onto upper surface 313 of second dielectric layer 213 and dried, and a dry film resistor (DFR) is laminated onto the paste. Subsequently, a photomask is attached to the DFR. After exposing PDP 200 with the photomask, a developing agent is injected from a barrier rib developing apparatus into PDP 200 beginning from an edge of second substrate 202, to develop the DFR.

At this point, volume enlargement portions 216a of the barrier ribs formed at the edges of display area 291 of second substrate 202 prevent the detachment of the DFR from the paste during the developing process.

Next, the raw material for forming barrier ribs 214 is removed from between barrier ribs 214 by sand blasting. The remaining DFR is exfoliated. The manufacture of barrier ribs 214 is complete when the resultant product is fired.

As described above, the PDP according to the present invention is constructed with volume enlargement portions formed in the barrier ribs, preventing detachment of the DFR from the barrier ribs during a developing process, and thereby preventing the distorting of the barrier ribs.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A plasma display panel, comprising:
a substrate;
a plurality of discharge electrodes located on the substrate; and
a plurality of barrier ribs that define a plurality of discharge cells and comprise volume enlargement portions.

2. The plasma display panel of claim 1, with the barrier ribs comprising at least one portion which is relatively longer than another portion, and the volume enlargement portions being formed on the longer portion.

3. The plasma display panel of claim 2, with the volume enlargement portions being formed by increasing the volume of central portions of the longer portion of the barrier ribs that are located between two adjacent shorter portions of the barrier ribs.

4. The plasma display panel of claim 2, with the barrier ribs comprising first barrier ribs extending in one direction of the substrate, and second barrier ribs extending in another direction of the substrate and being combined with the first barrier ribs to surround the plurality of discharge cells.

5. The plasma display panel of claim 4, with the second barrier ribs being longer than the first barrier ribs, and the volume enlargement portions being formed in central portions of the second barrier ribs that are located between two adjacent first barrier ribs.

6. The plasma display panel of claim 5, with the volume enlargement portions being formed by increasing the volume of second barrier ribs from sidewalls of the two adjacent first barrier ribs towards the central portion of the second barrier ribs.

7. The plasma display panel of claim 4, with the discharge cells defined by the barrier ribs having rectangular horizontal cross-sections.

8. The plasma display panel of claim 1, with the substrate comprising a display area where an image is displayed and a non-display area where the discharge electrodes are electrically connected to external terminals, and the barrier ribs on which the volume enlargement portions are formed being formed along edge regions of the display area.

9. The plasma display panel of claim 1, with the volume enlargement portions being formed by gradually increasing the volume of the barrier ribs from the center of the substrate towards the edge regions of the substrate.

10. A plasma display panel comprising:
a plurality of substrates;
a plurality of discharge electrodes that are located on the substrates and comprise a pair of sustain discharge electrodes that generate sustain discharge and address electrodes crossing the sustain discharge electrodes;
a plurality of barrier ribs that are located on the substrate to define a plurality of discharge cells and are constructed with volume enlargement portions; and
phosphor layers formed in the discharge cells.

11. The plasma display panel of claim 10, with the barrier ribs on which the volume enlargement portions are formed being longer than the barrier ribs on which no volume enlargement portions are formed.

12. The plasma display panel of claim 11, with the volume enlargement portions being formed by increasing the volume of central portions of the barrier ribs that define one discharge cell relative to the volume of other portions of the battier ribs in the edge regions of the substrate.

13. The plasma display panel of claim 10, with the barrier ribs comprising first barrier ribs extending in one direction of the substrate, and second barrier ribs extending in another direction of the substrate, with the first barrier ribs and the second barrier ribs being combined with each other to surround each of the plurality of discharge cells.

14. The plasma display panel of claim 13, with the second barrier ribs being longer than the first barrier ribs, and the volume enlargement portions being formed by gradually increasing the volume of second barrier ribs from sidewalls of the first barrier ribs towards the central portions of the second barrier ribs that are located between two adjacent first barrier ribs.

15. The plasma display panel of claim 13, with the second barrier ribs being parallel to the address electrodes.

16. The plasma display panel of claim 10, with the substrate comprising a display area where an image is displayed and a non-display area where the discharge electrodes are electrically connected to external terminals, and the barrier ribs on which the volume enlargement portions are formed being formed along edge regions of the display area.

17. The plasma display panel of claim 10, with the volume enlargement portions being formed by gradually increasing the volume of the barrier ribs from the center of the substrate towards the edge regions of the substrate.
